(19) United States
(12) Patent Application Publication
(10) Pub. No.: US 2018/0003029 A1
(43) Pub. Date: Jan. 4, 2018

(54) FLUID MONITORING USING RADIO FREQUENCY IDENTIFICATION

(71) Applicant: HALLIBURTON ENERGY SERVICES, INC., Houston, TX (US)

(72) Inventors: Mark Roberson, Cary, NC (US); Scott Goodwin, Chapel Hill, NC (US)

(73) Assignee: HALLIBURTON ENERGY SERVICES, INC., Houston, TX (US)

(21) Appl. No.: 15/536,089

(22) PCT Filed: Feb. 4, 2015
(86) PCT No.: PCT/US2015/014433

§ 371 Date: Jun. 14, 2017

(51) Int. Cl. E21B 47/00; E21B 17/10; E21B 33/14; G01V 15/00

(52) U.S. Cl. CPC E21B 47/0005; G01V 15/00; E21B 17/1014; E21B 33/14

(57) ABSTRACT

A system for fluid monitoring in a borehole for extracting hydrocarbons includes a casing to transport hydrocarbons, the casing defining an annulus between the casing and borehole wall. The system further includes a centralizer, coupled to the casing, to center the casing within the borehole. The system further includes a sensor unit, including a radio frequency identification (RFID) interrogator, positioned on the centralizer to monitor one or more fluids, including RFID tags, in the annulus.

### BACKGROUND

A cased borehole typically possesses an annular space between the casing and the formation wall that is permanently sealed with cement. This layer of cement may be referred to as a “cement sheath.” A properly formed cement sheath should fill all or nearly all of the annular space and should bond tightly to both the casing and the formation. In order to increase the strength of the bond, a cleaning fluid such as spacer fluid may be used to displace an oil-based drilling fluid in the annulus and clean the casing in preparation for adherence to a water-based cement slurry. In turn, the spacer fluid in the annulus may then be displaced by the cement slurry, which sets to form the sheath.

During a cementing operation, the drilling fluid should be fully displaced by the spacer fluid, and the spacer fluid should be fully displaced by the cement slurry. If full displacement fails to occur, then the integrity of the sheath and the strength of the cement bonds may be less than desired. Additionally, the correct amount of each fluid should be used. Too little fluid may result in decreased bond strength, reduced coverage, or compromised integrity, while too much fluid wastes resources.

Due to irregularities in the formation that surrounds the borehole, estimating the needed volume of fluids can be difficult. A caliper logging tool, which may have one or more sonic or ultrasonic receivers and one or more sonic or ultrasonic transmitters, may be lowered into the borehole to measure the size and shape of the borehole at various depths as a step toward estimating the volume of fluids required. Specifically, sonic or ultrasonic waves may be transmitted from the logging tool, and reflected waves from the formation may be received, recorded, processed, and interpreted to evaluate the annular space between the casing and the formation wall. However, even with these measurements, the process for determining required fluid volumes is error prone, due not only to measurement errors, but also due to unpredictable fluid losses into the formation.

### BRIEF DESCRIPTION OF THE DRAWINGS

Accordingly, there are disclosed herein certain systems and methods for annular fluid monitoring using radio frequency identification (RFID). In the following detailed description of the various disclosed embodiments, reference will be made to the accompanying drawings in which:

FIG. 1 is a contextual view of an illustrative cementing environment;

FIG. 2 is a side view of an illustrative bow-spring centralizer;

FIG. 3 is a cross-sectional view of an illustrative fluid monitoring system; and

FIG. 4 is a flow diagram of an illustrative fluid monitoring method.

It should be understood, however, that the specific embodiments given in the drawings and detailed description thereto do not limit the disclosure. On the contrary, they provide the foundation for one of ordinary skill to discern the alternative forms, equivalents, and modifications that are encompassed together with one or more of the given embodiments in the scope of the appended claims.

### NOTATION AND NOMENCLATURE

Certain terms are used throughout the following description and claims to refer to particular system components and configurations. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or a direct electrical or physical connection. Thus, if a first device couples to a second device, that connection may be through a direct electrical connection, through an indirect electrical connection via other devices and connections, through a direct physical connection, or through an indirect physical connection via other devices and connections in various embodiments.

### DETAILED DESCRIPTION

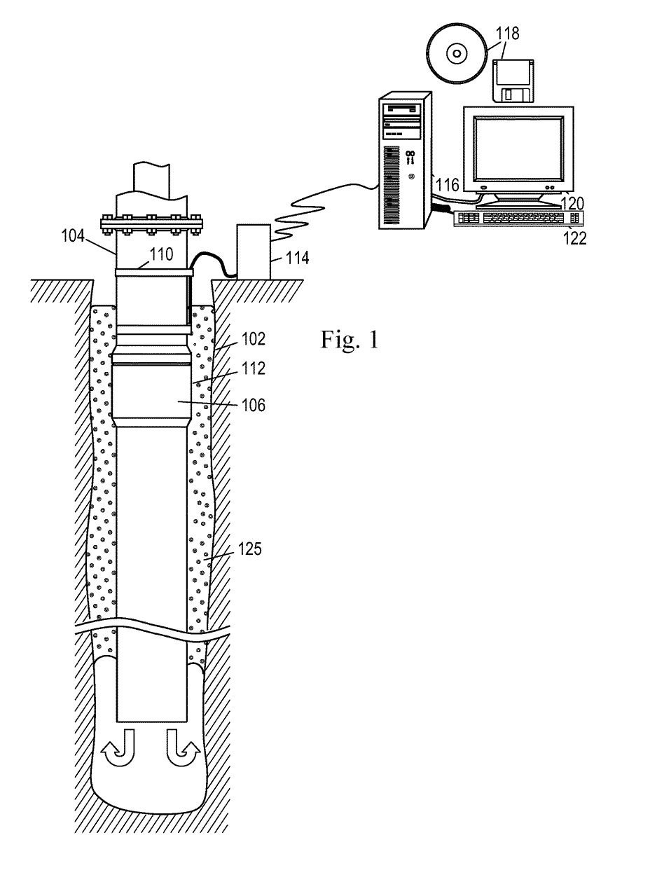

The issues identified in the background are at least partly addressed by systems and methods for fluid monitoring. The disclosed systems and methods are best understood in terms of the context in which they are employed. Accordingly, FIG. 1 shows an illustrative borehole 102 that has been drilled into the earth. Such boreholes are routinely drilled to ten thousand feet or more in depth and can be steered horizontally for perhaps twice that distance. During the drilling process, the driller circulates a drilling fluid to clean cuttings from the bit and carry them out of the borehole. In addition, the drilling fluid is normally formulated to have a desired density and weight to approximately balance the pressure of native fluids in the formation. Thus the drilling fluid itself can at least temporarily stabilize the borehole and prevent blowouts.

To provide a more permanent solution, the driller inserts a casing string 104 into the borehole. The casing string 104 is normally formed from lengths of tubing joined by threaded tubing joints 106. The driller connects the tubing lengths together as the casing string is lowered into the borehole.

The casing string 104 may be coupled to a measurement unit 114 that senses one or more parameters along the length of the casing including temperature, pressure, strain, acoustic (noise) spectra, acoustic coupling, and chemical (e.g., hydrogen or hydroxyl) concentration. The measurement unit 114 may process each measurement and combine it with other measurements for that point to obtain a high-resolution measurement of that parameter. Though FIG. 1 shows a cable as the sensing element, alternative embodiments of the system may employ an array of spaced-apart sensors that communicate measurement data via wired or wireless channels to the measurement unit 114. A data processing system 116 may periodically retrieve the measurements as a function of position and establish a time record of those measurements. Software, represented by information storage media 118, runs on the data processing system 116 to collect the measurement data and organize it in a file or database. The software further responds to user input via a keyboard or other input mechanism 122 to display the measurement data as an image or movie on a monitor or other output mechanism 120. Some software embodiments may provide an audible and/or visual alert to the user.

To cement the casing 104, the drilling crew injects a cement slurry 125 into the annular space (typically by pumping the slurry through the casing 104 to the bottom of the borehole, which then forces the slurry to flow back up through the annular space around the casing 104). It is expected that the software and/or the crew will be able to monitor the measurement data in real time or near real time to observe the profile of the selected parameter (i.e., the value of the parameter as a function of depth) and to observe the evolution of the profile (i.e., the manner in which the profile changes as a function of time).

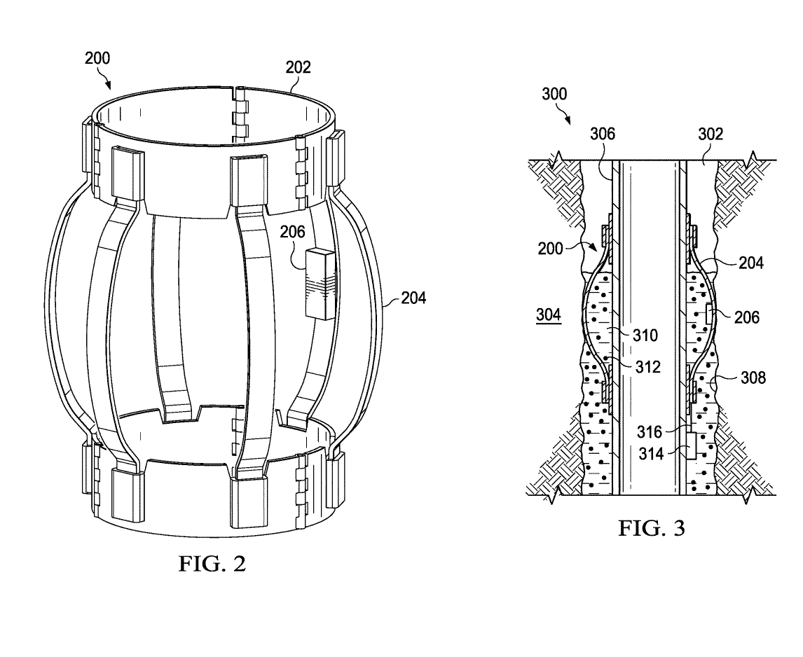

FIG. 2 shows an illustrative centralizer 200, which includes hinged collars 202 and bow springs 204. The illustrated centralizer 200 may be positioned on a casing. Specifically, the collars 202 couple the bow springs 204 to the casing, and the bow springs 204 press against the borehole wall to keep the casing in the center of the borehole during a cementing job. Consequently, the cement sheath thickness is evenly distributed around the casing. If the casing is cemented off center, there is a high risk that a channel of drilling fluid or contaminated cement will be left where the casing contacts the formation, creating an imperfect seal. Additionally, an even cement sheath is less likely to suffer from cracks and breaches than an uneven cement sheath. Although a clamp-on bow spring centralizer is illustrated, other types of centralizers may be used as part of a fluid monitoring system or method in various embodiments. For example, welded centralizers, non-welded centralizers, and cast centralizers may be used. Additionally, rigid centralizers, positive bow centralizers, semi-rigid centralizers, and spiral-fin centralizers may be used. The selected centralizer preferably includes a space for fluid flow between the casing and at least a spaced-away portion of the centralizer.

The centralizer 200 also includes one or more sensor units 206. As illustrated, a sensor unit 206 is coupled to the inside surface of a bow spring 204, but in various embodiments sensor units 206 may be coupled to the centralizer directly and indirectly in multiple ways and locations. The sensor unit 206 may be attached by welding, soldering, using glue, using epoxy, and the like. The sensor unit 206 includes a radio frequency identification (RFID) interrogator which receives RFID codes from RFID tags. Operation of the sensor unit 206 is discussed further with respect to FIG. 3.

FIG. 3 shows a cross section of a borehole and illustrative fluid monitoring system 300 in at least one embodiment. A borehole 302 has been drilled into the target formation 304, and the target formation 304 may include multiple layers, each layer with a different type of rock formation, including the hydrocarbon-containing target formation. The system 300 for fluid monitoring includes a casing 306 to transport the hydrocarbons, and the casing 306 defines an annulus between the casing 306 and borehole wall 308. The system 300 also includes a centralizer 200, coupled to the casing 306, to center the casing 306 within the borehole 302. As illustrated, the centralizer 200 uses bow springs 204 to contact the borehole wall 308 to prevent the casing 306 from becoming off center. The system 300 also includes a sensor unit 206, including a RFID interrogator, positioned on the centralizer 200 to monitor one or more fluids 310, including RFID tags 312, in the annulus. As illustrated, the sensor unit 206 is coupled to the inside surface of a bow spring 204, but in various embodiments sensor units 206 may be coupled to the centralizer directly and indirectly in multiple ways and locations.

A RFID tag 312 includes a chip and an antenna. For passive RFID tags, the antenna powers the chip when current is induced in the antenna by a RF signal from the interrogator. The tag 312 returns a unique identification code by modulating and re-transmitting the RF signal. Passive RFID tags are gaining widespread use due to their low cost, indefinite life, simplicity, small size, and efficiency. Unlike active tags, which require a battery to transmit, passive tags require no battery. In various embodiments, active and/or passive tags may be used. In at least one embodiment, an integrated, passive RFID tag 312 includes a data sensing component, an optional memory, and an antenna. Excitation energy is received by the antenna and powers the data sensing component, which senses a present condition and/or accesses one or more stored sensed conditions from the optional memory. The conditions are transmitted to the interrogator along with an ID code by the antenna. In at least one embodiment, the ID code is 1 bit.

In at least some embodiments, the one or more fluids 310 flow between the sensor unit 206 and the casing 306, which are arranged to create a well-defined interrogation volume. The casing 306 is made of steel and is thus electrically conductive, blocking the interrogation signal from penetrating into the casing interior. The spaced-away sensor unit 206 is oriented towards the casing 306, with a sufficient signal strength to ensure that the interrogation region volume is relatively insensitive to the fluid conductivity. The various fluids 310, which may include a drilling fluid, one or more spacer fluids, a cement slurry, or a displacer fluid depending upon which stage of the cementing job is in progress, pass through the interrogation region. By positioning the sensor unit 206 away from the casing 306, the sensor unit 206 avoids disruptive vibrations traveling through the casing 306.

The drilling fluid may include a first set of RFID tags, the spacer fluid may include a second set of RFID tags, and the cement slurry may include a third set of RFID tags. In at least one embodiment, the first set of RFID tags may include a first ID code, the second set of RFID tags may include a second ID code, and the third set of RFID tags may include a third ID code. As such, the sensor unit 206 may receive one of three types of ID codes in this example.

Depending upon the ID codes received, the type of fluid adjacent to the sensor unit 206 may be determined. Accordingly, it may be determined if spacer fluid has fully displaced drilling fluid (if all or very many spacer fluid ID codes are received with very few drilling fluid ID codes are received), or if the cement slurry has fully displaced spacer fluid (if all or very many cement slurry ID codes are received with very few spacer fluid ID codes are received). It may also be determined if a fluid 310 has reached the vertical level of the sensor unit 206 in at least one embodiment (if a particular ID code is received). Accordingly, parameters of the cementing job may be modified according to real-time data. For example, the pump rate of the cement slurry may be slowed upon the first reception of a cement slurry ID code because the sensor unit 206 may be placed at a vertical level near the top of the desired cement sheath. In this way, many parameters of the cementing job, particularly those where fluid 310 is involved may be adjusted. Furthermore, remediation actions can be taken if the fluid 310 is not detected or is detected at an inappropriate time.

In various embodiments, the sensor unit may measure a density of the RFID tags, and/or a rate at which the RFID tags flow past the sensor unit. For example, the formulation of the fluid 310 may be adjusted based on the rate at which the RFID tags flow past the sensor to increase or decrease the viscosity of the fluid 310. Additionally, by counting the number of RFID tag detections within a time period, the flow rate and the presence of unwanted mixtures can be determined.

The system 300 further includes a communication system 314 coupled to the sensor unit 206 by a wired channel 316 or by a wireless channel, and the communication system 314 may be configured to transmit fluid data such as RFID codes and/or sensor data to a receiver at the surface of the borehole 302 via wired or wireless channels.

In another embodiment, rather than one code for each fluid 310, the first set of RFID tags may include a first set of ID codes, the second set of RFID tags may include a second set of ID codes, and the third set of RFID tags may include a third set of ID codes. These sets of ID codes may correspond to ranges of codes or may be random or semi-random in various embodiments. For example, the first set of ID codes may be within a range of two threshold ID codes. As such, it may be identified as being part of the first set by a processor in the sensor unit 206, RFID interrogator, or communications unit 314.

In some variations, each RFID tag has a unique serial number, permitting the system 300 to count the number of tags. This permits the system 300 to measure flow rate, tag concentration, fluid loss rates and the like. In such systems, the tags for each different fluid may correspond to a different kind of tag, rather than different ID codes.

In at least some embodiments, two interrogation stations are spaced apart in the annulus. This enables transit times between stations to be monitored, and fluid flow rate to be calculated. Fluid losses can be detected if the count rates are different at the two stations, or if a third interrogation station is used to compare the transit times between the first two stations and the last two stations.

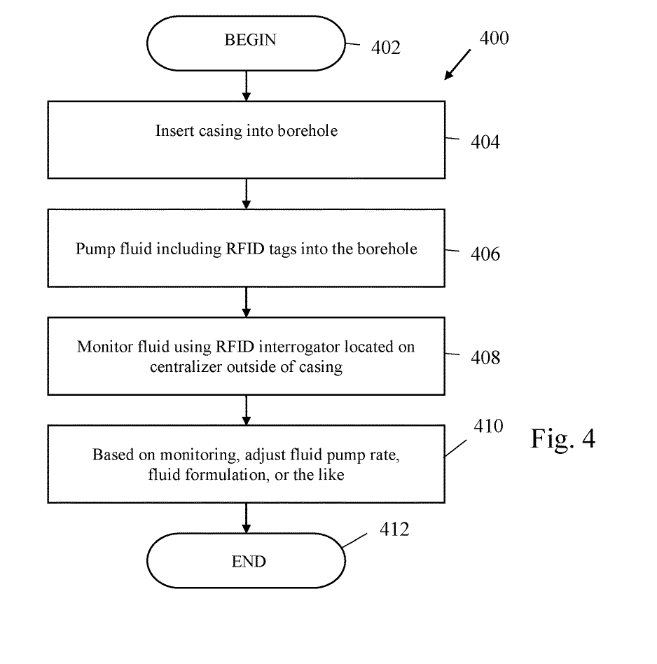

FIG. 4 is a flow diagram of an illustrative method 400 of fluid monitoring beginning at 402 and ending at 412. At 404, a casing is inserted into the borehole, the casing defining an annulus between the casing and borehole wall. The casing is coupled to a centralizer to center the casing within the borehole, and a sensor unit is positioned on the centralizer, e.g. on a bowstring.

At 406, one or more fluids including radio frequency identification (RFID) tags is pumped into the borehole. At 408, the one or more fluids in the annulus are monitored using a sensor unit, including a RFID interrogator, positioned on the centralizer. The one or more fluids, which may include may include drilling fluid, spacer fluid, a cement slurry, and/or the like, may flow between the sensor unit and the casing. The drilling fluid may include a first set of RFID tags, the spacer fluid may include a second set of RFID tags, and the cement slurry may include a third set of RFID tags.

At 410, one or more parameters of the cement job are adjusted based on the monitoring. For example, the fluid pump rate may be adjusted, the fluid formulation may be adjusted, or the like.

A system for fluid monitoring in a borehole for extracting hydrocarbons includes a casing to transport hydrocarbons, the casing defining an annulus between the casing and borehole wall. The system further includes a centralizer, coupled to the casing, to center the casing within the borehole. The system further includes a sensor unit, including a radio frequency identification (RFID) interrogator, positioned on the centralizer to monitor one or more fluids, including RFID tags, in the annulus.

The centralizer may be a bow-spring centralizer and the sensor unit may be positioned on a bow spring of the bow-spring centralizer. The fluids may flow between the sensor unit and the casing. The system may further include a communication system coupled to the sensor unit, and the communication system may be configured to transmit fluid data. The communication system may transmit the fluid data over a communications cable to a receiver at the surface of the borehole. The communication system may transmit the fluid data wirelessly to a receiver at the surface of the borehole. The fluids may include a drilling fluid, a spacer fluid, and a cement slurry. The drilling fluid may include a first set of RFID tags, the spacer fluid may include a second set of RFID tags, and the cement slurry may include a third set of RFID tags. The first set of RFID tags may include a first ID code, the second set of RFID tags may include a second ID code, and the third set of RFID tags may include a third ID code. The first set of RFID tags may include a first set of ID codes, the second set of RFID tags may include a second set of ID codes, and the third set of RFID tags may include a third set of ID codes. The first set of ID codes may include a first range of ID codes, the second set of ID codes may include a second range of ID codes, and the third set of ID codes may include a third range of ID codes. The centralizer may be a bow-spring centralizer or a rigid centralizer. The sensor unit may measure a density of the RFID tags. The sensor unit may measure a rate at which the RFID tags flow past the sensor unit.

A method of fluid monitoring in a borehole for extracting hydrocarbons includes inserting a casing into the borehole, the casing defining an annulus between the casing and borehole wall, the casing coupled to a centralizer to center the casing within the borehole; pumping one or more fluids including radio frequency identification (RFID) tags into the borehole; and monitoring the one or more fluids in the annulus using a sensor unit, including a RFID interrogator, positioned on the centralizer.

The method may further include positioning the sensor unit on the centralizer. The method may further include positioning the sensor unit on a bow spring of the centralizer. The one or more fluids may flow between the sensor unit and the casing. The one or more fluids may include a drilling fluid, a spacer fluid, and a cement slurry. The drilling fluid may include a first set of RFID tags, the spacer fluid may include a second set of RFID tags, and the cement slurry may include a third set of RFID tags.

While the present disclosure has been described with respect to a limited number of embodiments, those skilled in the art will appreciate numerous modifications and variations therefrom. It is intended that the appended claims cover all such modifications and variations.

What is claimed is:

1. A system for fluid monitoring in a borehole for extracting hydrocarbons comprising:
a centralizer, coupled to a casing, to center the casing within the borehole; and
a sensor unit, comprising a radio frequency identification (RFID) interrogator, positioned on the centralizer to monitor one or more fluids, comprising RFID tags, in an annulus of the borehole.

2. The system of claim 1, wherein the centralizer is a bow-spring centralizer and the sensor unit is positioned on a bow spring of the bow-spring centralizer.

3. The system of claim 1, wherein the fluids flow between the sensor unit and the casing.

4. The system of claim 1, further comprising a communication system coupled to the sensor unit, the communication system configured to transmit fluid data.

5. The system of claim 4, wherein the communication system transmits the fluid data over a communications cable to a receiver at the surface of the borehole.

6. The system of claim 4, wherein the communication system transmits the fluid data wirelessly to a receiver at the surface of the borehole.

7. The system of claim 1, wherein the fluids comprise a drilling fluid, a spacer fluid, and a cement slurry.

8. The system of claim 7, wherein the drilling fluid comprises a first set of RFID tags, the spacer fluid comprises a second set of RFID tags, and the cement slurry comprises a third set of RFID tags.

9. The system of claim 7, wherein the first set of RFID tags comprise a first ID code, wherein the second set of RFID tags comprise a second ID code, and wherein the third set of RFID tags comprise a third ID code.

10. The system of claim 7, wherein the first set of RFID tags comprise a first set of ID codes, wherein the second set of RFID tags comprise a second set of ID codes, and wherein the third set of RFID tags comprise a third set of ID codes.

11. The system of claim 10, wherein the first set of ID codes comprises a first range of ID codes, wherein the second set of ID codes comprises a second range of ID codes, and wherein the third set of ID codes comprises a third range of ID codes.

12. The system of claim 1, wherein the centralizer is a type of centralizer selected from the group consisting of bow-spring centralizer and rigid centralizer.

13. The system of claim 1, wherein the sensor unit measures a density of the RFID tags.

14. The system of claim 1, wherein the sensor unit measures a rate at which the RFID tags flow past the sensor unit.

15. A method of fluid monitoring in a borehole for extracting hydrocarbons comprising:
pumping one or more fluids comprising radio frequency identification (RFID) tags into the borehole; and
monitoring the one or more fluids using a sensor unit, comprising a RFID interrogator, positioned on a centralizer within an annulus of the borehole.

16. The method of claim 15, further comprising positioning the sensor unit on the centralizer.

17. The method of claim 15, further comprising positioning the sensor unit on a bow spring of the centralizer.

18. The method of claim 1, wherein the one or more fluids flow between the sensor unit and the casing.

19. The method of claim 1, wherein the one or more fluids comprise a drilling fluid, a spacer fluid, and a cement slurry.

20. The method of claim 19, wherein the drilling fluid comprises a first set of RFID tags, the spacer fluid comprises a second set of RFID tags, and the cement slurry comprises a third set of RFID tags.
